(19) United States
(12) Patent Application Publication
(10) Pub. No.: US 2013/0227086 A1
(43) Pub. Date: Aug. 29, 2013

(54) SYSTEMS AND METHODS FOR DATA PROCESSING IN CONJUNCTION WITH MEDIA PRESENTATIONS

(71) Applicant: Yap.tv, Inc., (US)

(72) Inventor: Trevor Stout, Los Altos, CA (US)

(73) Assignee: YAP.TV, INC., Los Altos, CA (US)

(21) Appl. No.: 13/772,226

(22) Filed: Feb. 20, 2013

Related U.S. Application Data
(60) Provisional application No. 61/601,518, filed on Feb. 21, 2012.

(51) Int. Cl. H04L 29/08

(52) U.S. Cl. CPC H04L 67/306
USPC 709/219

(57) ABSTRACT

Systems and methods of the present disclosure provide enhanced social networking to users of remote computing devices. Various embodiments disclosed herein help enable users to interact with other participants in real-time and in relation to experiencing live or recorded media content. A method according to one embodiment of the present disclosure includes detecting, by a computing device, media presented via a user interface of the computing device. In response to detecting the presentation of the media, the computing device identifies an entity associated with the media being presented, retrieves information that is related to both the entity and the presented media, and displays the retrieved information via the user interface.

### RELATED APPLICATIONS

The present application claims priority to Provisional U.S. Patent Application Ser. No. 61/601,518 filed Feb. 21, 2012 and entitled “System and Method for Connecting with Friends of Similar Taste in Media Presentations,” and is a continuation-in-part application of, and claims priority to, U.S. patent application Ser. No. 13/246,793, filed Sep. 27, 2011 and entitled “System and Method for Enhanced Social-Network-Enabled Interaction,” which claims priority to Provisional U.S. Patent Application Ser. No. 61/386,926, filed Sep. 27, 2010 and entitled “System and Method for Enhanced Social-Network-Enabled Interaction,” the disclosures of which are hereby incorporated by reference in their entirety herein.

### FIELD OF THE TECHNOLOGY

At least some embodiments of the present disclosure relate to providing real-time interaction between participants over a network and relative to scheduled and/or unscheduled media events.

### BACKGROUND

Social networks in the context of human society is a natural phenomena that has been studied and manipulated over several centuries. More relevant to the present time, social networking services have for many become as much a part of daily living as using a telephone, for example. A social networking service is usually an Internet based service, platform, or site, that has been implemented to build on and reflect what we already know about the nature of social networks. Social networking services visually reflect and help build social relations among people having shared interests, values, and/or activities. A social network service essentially consists of a representation of each user (i.e., a profile), his/her social links, and a variety of additional services.

It is widely believed that social networking services have made it possible for people to become more active in socializing with and relating to “like-minded” people. However, some would argue that such relationships built on, or maintained, within the sterile environment of the Internet are shallow and lack the physical interaction that is intrinsic to the nature of human beings. In an effort to compensate for the lack of a more personal interaction within social networking services, scientists and engineers have conjured various means for closing the geographic divide that is inherent to online social networking. Such efforts include, for example, providing real-time audio and video exchange between members of a social network. Employing additional human senses to the online social networking experience have improved the overall experience. However, any such exchange continues to occur in a somewhat artificial, or studio-like, environment. In other words, the ability to interact with other people while simultaneously engaging in real-life activities is lacking For example, the level of interaction between a mother and daughter working together in a kitchen to prepare a meal simply cannot be replicated when the mother and daughter are physically separated with each residing in their own unique environment. Other than verbal communication, there is minimal real-time sharing of real-life experience within a social network service.

Additionally, users of social networks may wish to identify other entities associated with digital media (such as music, movies, or other types of audio/video presentations) of interest to the user. Such entities may include: a user's real-life friends; artists or producers of media the user accesses; and websites, blogs, or social network content including reviews and commentary regarding music, movies, and other forms of media. Among other things, embodiments of the present disclosure help users identify, connect, and share information with such entities, as well as to identify new forms of media of interest to the user.

### SUMMARY OF THE DESCRIPTION

Various embodiments disclosed herein help enable users interact with other participants experiencing live or recorded media content, and to identify media of interest to them based on aggregating information from different sources.

A method according to one embodiment of the present disclosure includes detecting, by a computing device, media presented via a user interface of the computing device. In response to detecting the presentation of the media, the computing device identifies an entity associated with the media being presented, retrieves information that is related to both the entity and the presented media, and displays the retrieved information via the user interface.

A tangible, non-transitory, computer-readable medium according to another embodiment of the present disclosure stores instructions that, when executed, cause a computing device to detect media presented via a user interface of the computing device; in response to detecting the presentation of the media, identify an entity associated with the media being presented; retrieve information that is related to both the entity and the presented media; and display, via the user interface, the retrieved information.

A system according to another embodiment of the present disclosure comprises a user interface, a processor in communication with the user interface, and a memory in communication with the processor. The memory stores instructions that, when executed by the processor, perform a method comprising: detecting media presented via a user interface; in response to detecting the presentation of the media, identifying an entity associated with the media being presented; retrieving information that is related to both the entity and the presented media; and displaying, via the user interface, the retrieved information.

Both the foregoing summary and the following detailed description are exemplary and explanatory only and are not restrictive of the exemplary embodiments disclosed herein.

### BRIEF DESCRIPTION OF THE DRAWINGS

The embodiments are illustrated by way of example and not limitation in the figures of the accompanying drawings in which like references indicate similar elements.

FIG. 1 is a block diagram showing a functional overview of an exemplary system for social-networked interaction in accordance with one embodiment;

FIG. 2a is a diagram showing a simplified overview of an exemplary system for social-networked interaction in accordance with one embodiment;

FIG. 2b is a diagram showing a simplified overview from the perspective of a local head end of an exemplary system for social-networked interaction in accordance with one embodiment;

FIG. 2c is a diagram showing a simplified overview from the perspective of a user device of an exemplary system for social-networked interaction in accordance with one embodiment;

FIG. 3 is a block diagram showing an overview of an XMPP architecture of an exemplary system for social-networked interaction in accordance with one embodiment

FIG. 4 is a block diagram showing a spoiler blocking configuration of an exemplary system for social-networked interaction in accordance with one embodiment; and

FIG. 5 is a block diagram showing various computing and networking hardware used in the implementation of an exemplary system for social-networked interaction in accordance with one embodiment.

FIG. 6 is a flow diagram showing an exemplary process for associating social network friends with various types of media.

FIG. 7 is a block diagram of an exemplary system according to various aspects of the present disclosure.

FIG. 8 is a flow diagram showing another exemplary process according to various aspects of the present disclosure.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description.

References throughout this specification to “one embodiment,” “an embodiment,” or “some embodiments” do not necessarily refer to the same embodiment. The features, structures, and characteristics described in connection with any particular embodiment may be included in other embodiments.

In one embodiment, the system and method described herein comprise social networking related services that allow participants to interact in real-time in direct relation to shared events. The system allows participants to share thoughts and ideas that are based on, or stem from, the simultaneous viewing of content. The system further facilitates social-network-enabled interaction through real-time control, participation, and communication relative to entertainment and/or educational content.

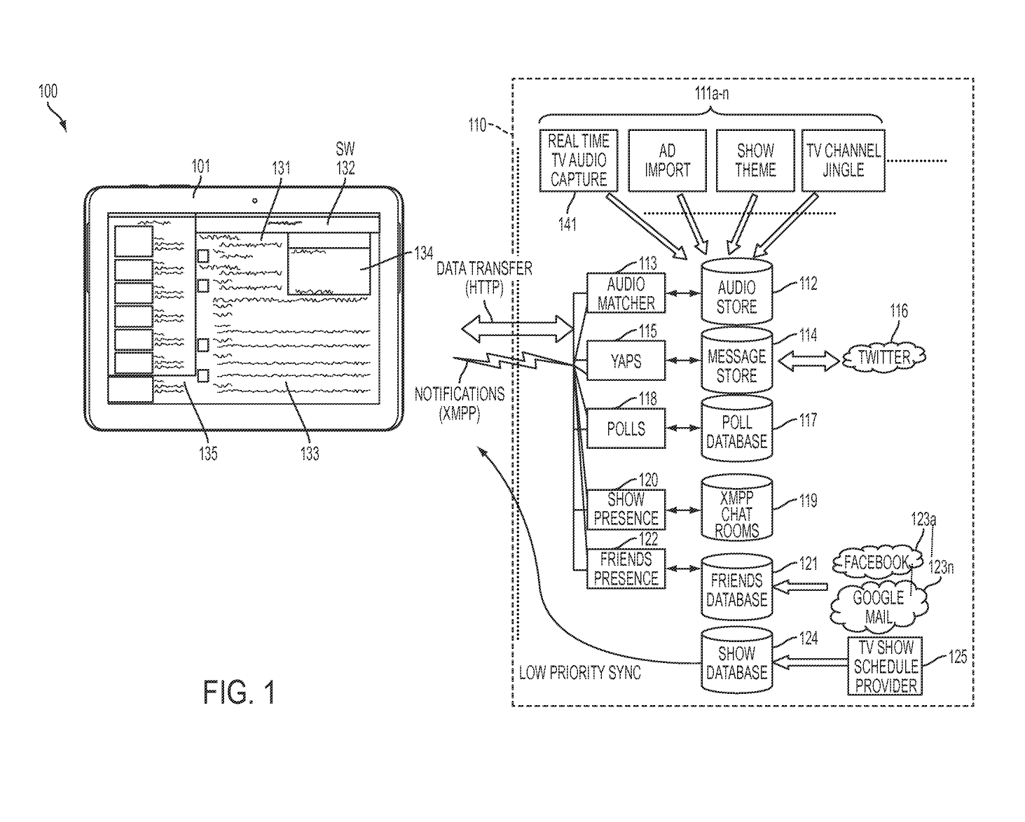

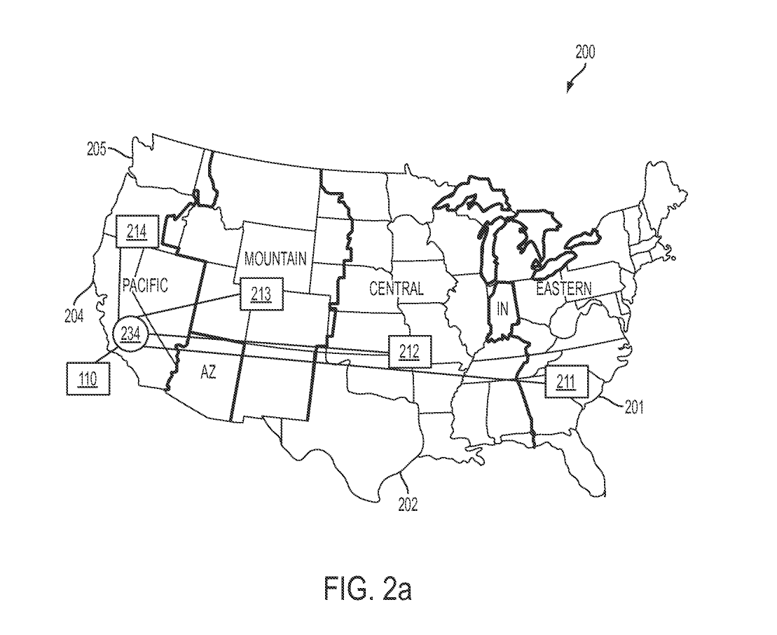

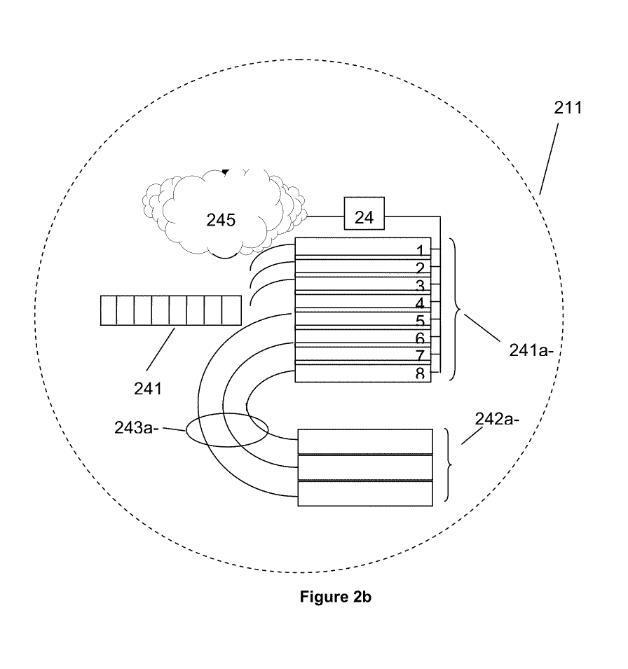

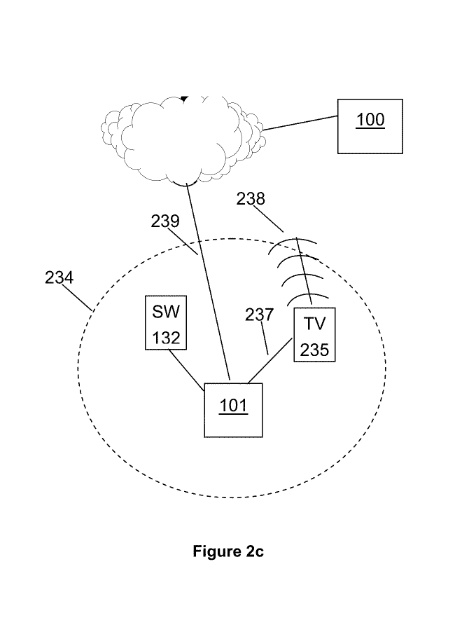

FIG. 1 shows a functional overview of system 100 with an exemplary operating center (system) 110 and an exemplary client device 101, according to one embodiment of the system and method disclosed herein, with an exemplary list of services. Shown at the top right of FIG. 1 is an exemplary list of external services 111a-n, such as real-time TV audio capture, further discussed in the subsequent description of FIG. 2. The exemplary services 111a-n are used to import external data, such as TV guide line-ups and real-time audio collected in a proprietary system in a head-end 141 (also further discussed in the description of FIG. 2). External data for import may further include advertising imports from advertising partners, both from proprietary advertising partners of the services offered by the system in conjunction with network, cable and satellite, as well as from other advertising partners. Additional imports may be made in some cases of show themes of partnering shows and television channel jingles to overlay the recognized features, and also future additional enhancements and expansion.

As the user connects using device 101, which has application 132 running in the background, the system presents a screen 131 to the user. Screen 131 displays the current line-up of channels 135. In one embodiment, application 132 runs as an application (e.g., browser plug-in) on a browser and/or an operating system, as provided by the device maker and/or operator. The channel currently playing may be highlighted for emphasis. Window 133 displays the current discussions (e.g., “yaps”) relating to the programming.

As described herein, the system utilizes both the transfer of the data in the visual field, as well as notifications and the transfer of a sound stream to identify the programming (i.e., channel) that the user is currently viewing. As used herein, the terms “view”, “viewing”, “watch” and “watching” may be used interchangeably and convey the act of hearing and/or seeing a media based event (e.g., television, program, movie feature, music, etc.).

The audio matcher module 113 is configured to match the audio of the user's channel to all channels available in the audio capture head end 141, which is part of system 200. The audio capture head 141 is discussed in greater detail in the discussion below for FIG. 2.

Module 113 is in communication with an audio store 112, which maintains audio data for an arbitrary length of time such as, for example, two weeks (although this length of time could just as well be two months or two years, for example), thus enabling the system to match the audio of programs previously recorded by, for example, a digital video recorder (DVR). Moreover, the discussions are stored in data store 115, which is connected to message store 114, further described below. In one embodiment, either the content or the users may launch certain polls from poll module 118. For example, various polls may be displayed as an overlay 134 on screen 131. As used herein, a poll may comprise any one or more inquiries that are defined by users, administrators, or any designated third party for the purposes of obtaining information from one or more users of the disclosed system.

In one embodiment, module 113 may be implemented at the client device 101 (i.e., as a component of SW 132) rather than at the operating center 110, for example, in order to reduce the quantity of data that may be transmitted between the client 101 and operating center 110. Further, practitioners will appreciate that the features of the variously disclosed software and/or hardware modules may be implemented in a combination of operating-center-based and device-based software. Moreover, and as explained herein, the system illustrated in FIG. 1 is presented for explanation and may not include every element and component for which explanation is not necessary to those of ordinary skill in the art. For example, it should be appreciated that while not illustrated in FIG. 1, the client device 101 may similarly include many of the hardware components described relative to those of the operating center 110. Such components may include, for example, microprocessors and various memory structures used to carry out instructions for receiving and processing information, and transmitting and storing information.

Display of polling data may be configured, such that polls by networks, partner shows, advertisers, and/or users may be added. The poll results may then be collected from participating users and combined by any and all parties involved. Poll results may be stored in poll database 117, which is in communication with the polls module 118.

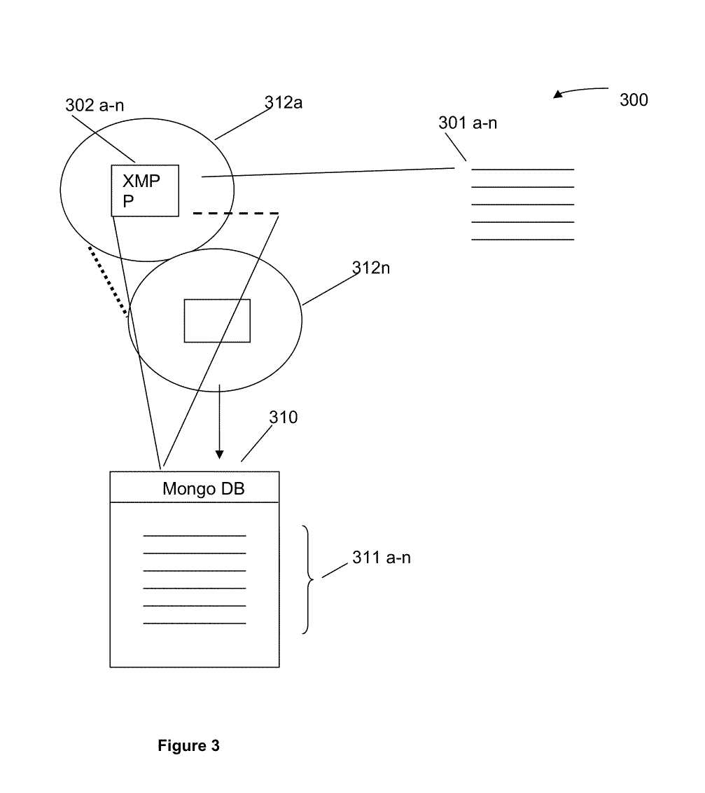

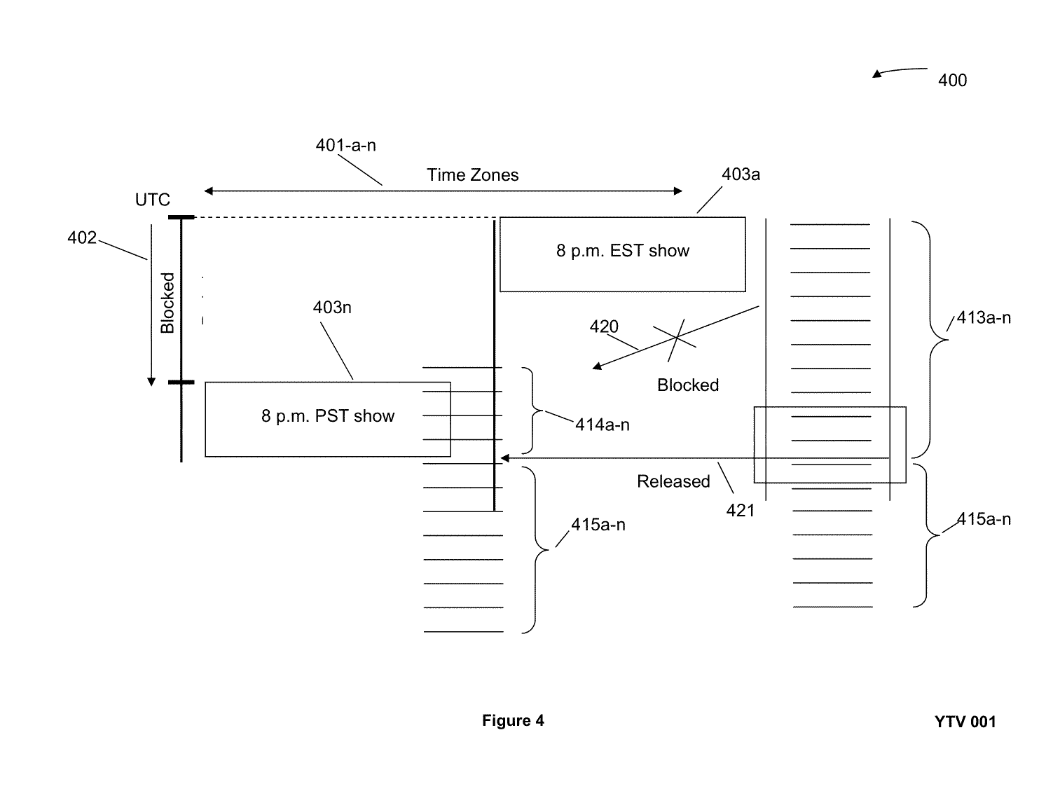

In one embodiment, chat rooms operate using an extensible messaging and presence protocol (XMPP) chat system, using in part, presence module 120, which communicates also with device 101, and XMPP chat room(s) 119 (as well as additional features further described below). Further, the friends presence module 122 may communicate with user device 101, enabling friends, for example, to “see” each other, as well as in some cases enabling direct offers, etc., by partners. In one embodiment, an enhanced architecture enables chat rooms to maintain, for example, millions of simultaneous participants, as further described in the discussions of FIG. 3 and FIG. 4 below.

Additional information in operating center 110 may include a friends presence module 122 and friends database 121. These modules may interface with existing or new services 123a through 123n, such as, for example, Facebook, MySpace, Ping, Google, chat, and the like. Show database 124 contains lists of current and previous content (e.g., programs, media events, etc.) in the electronic program guide (EPG). In one embodiment, EPG data is imported from external sources 125, including but not limited to such sources as Tribune, Gemstar/Newscorp, Microsoft, and the like.

In one embodiment, sound profile analysis is performed on a server in center 110 and is facilitated through execution of a sound matcher module 113, which digitally compares a sound stream with stored sound stream samples. The sound matcher 113 enables detection within in a few seconds, for example, of the channel or program that the user is viewing, and whether it is live or recorded, on a DVR for example, by comparing a sound stream from the current viewing with sound signatures from a plurality of live captured and/or previously captured sounds that are maintained within audio store database 112.

FIG. 2a illustrates a simplified exemplary overview of a system 200, according to one embodiment of the system and method disclosed herein. As illustrated by the simplified map 205 of the United States, content (i.e., broadcast media) is distributed across the country. A local head end 211, 212, 213, and 214, is respectively located in each time zone 201, 202, 203, and 204. In accordance with this embodiment, a user at location 234 in Los Angeles, is connected to operating center 110. This provides data collection within localized geographic regions, typically by time zone, such collection including the capture of sound data of some or many broadcasts across various time zones. In one embodiment, the objective may not necessarily be to capture all channels, but rather the top 20 to 100 channels nationwide, for example, while capturing as many of these channels as possible in each time zone.

Each head end, as illustrated in FIG. 2b in a detailed example of local head end 211, contains a set of receiver boxes 242a-n for receiving locally available cable and or satellite signals (not shown) and connected to a set of digital signal processor (DSP) units 241a-n. With occasional reference to FIG. 1, each of the DSP units, as shown in unit 241x, contains an eight-channel DSP, which DSP creates digital signatures of the sounds of the channels viewed and transmits those signatures via server 244 and Internet connection 245 to head end 141 located at center 110. In one embodiment, head end 141 collects this data nationwide from all time zones, or potentially even worldwide, and stores the data in the audio store database 112. In some scenarios, local head ends may be available in different geographic regions, such as, for example, Asia, Asia-Pacific, Europe, etc., or in different countries. This data may be used to match stored sound data with sound data from a user's device 101 in a location such as, for example, Los Angeles 234.

In the detailed example shown in FIG. 2c, the user interacts with a device 101, which may comprise any suitable hand-held computing device. The device uses a microphone (not shown) to collect sound information 237 emanating from television (TV) 235. Device 101 may comprise any suitable electronic device, including but not limited to, an iPhone, iPad, Blackberry, Android phone, or any other type of smart phone, tablet PC, or dedicated device having sufficient resources and capabilities to perform the functions disclosed herein.

The collected sound information 237 is processed by software 132 and transmitted via Internet connection 239, which connection could be, for example, a wireless connection, or any other suitable connection of various known wireless connections, to an operating center 110, as previously described in reference to FIG. 1.

In one embodiment, sound profile analysis is performed on a server in center 110 (shown in FIG. 1). This analysis is performed in sound matcher 113 (see FIG. 1) and enables detection, typically within a few seconds, of the channel and/or program that the user is currently viewing, and whether it is live or recorded, on a DVR for example, by comparing it with sound signatures from many live captured and previously captured sounds in audio store database 112 (see FIG. 1). In one embodiment, networking may be facilitated by way of 3G, 4G, or any other suitable wireless protocol, or any suitable local wireless connection, such as Wi-Fi, Bluetooth, etc., which is then connected via DSL or any other suitable networking means back into the Internet backbone.

FIG. 3 provides an overview of the XMPP architecture 300 in accordance with one embodiment. Because most XMPP servers have a limit of only a few thousand participants, in most situations such servers are clustered together, as shown in FIG. 3. Each server 312a-n has its own local roster of participants 301a-n, which could be a few hundred or a few thousand. A few hundred to a few thousand of these local XMPP clusters may be operated, for example, grouped into regions (with possibly additional servers in regional head ends 211-214, not shown), which arrangement has advantages described below. Those local and regional groups may then connect to database 310, which includes a global roster of participants 311a-n. In one embodiment, when a user signs in, the system locates the user in the global database and assigns a suitable local chat group from servers 312a-n, according to the user's current geographical location.

In one embodiment, the location of the user may be determined based on a global positioning system (GPS) device attached to the user's device 101. In various other embodiments, the geographic location of the device 101 (and user) may be determined and/or provided by way of a location defined in a user profile, a user profile captured from other social networks (e.g., Twitter, Facebook, MySpace, etc.), an IP address, cellular location, and the like.

By limiting the localization to a specific area, the system may provide local services such as spoiler alert or spoiler blocking, in accordance with one embodiment. Spoiler blocking prevents the chat or twitter posts of people in, for example, time zone 201 (the U.S. east coast) from reaching people in time zone 204 (the U.S. west coast) until the event under discussion has finished on the west coast, thus avoiding spoiling the show.

FIG. 4 provides an overview of an exemplary spoiler blocking system 400, according to one embodiment of the system and method disclosed herein. The arrow across the top of FIG. 4 illustrates the span of time zones 401a-n. In accordance with this example, the subject event occurs during time block 403a on the east coast, beginning at 8:00 p.m. EST, while the same show (i.e., event) occurs during time block 403n, beginning at 8:00 p.m. PST, on the west coast. “Tweets” 413a-n, sent from the start of time block 403a to the end of time block 403n, are blocked, as indicated by crossed out arrow 420. The system releases these tweets when the event finishes on the west coast (at the end of time block 403n), as indicated by arrow 421. Thus, users may enjoy even the last few seconds of the event without any spoilers. Prior to the end of the event, chat rooms on the west coast are kept separate from those on the east coast, and users in the west coast geographical region see only messages 414a-n. When the event has ended on the west coast, all messages 413a-n are released and synchronized with chat rooms on the west coast. Then, all messages 415a-n are the same in all chat rooms in all geographical areas.

The above description is presented for explanation only, and practitioners will appreciate that the disclosed system and method is applicable to multiple geographical chat regions and multiple airings of the same event. For example, an event appearing in a yet further western time zone, for example, Hawaii, could have its own chat room specific to it's geographical region, to which the spoiler blocking system could be similarly applied. A globally broadcast event might have time-delayed localized chat rooms worldwide, according to the time of showing in each region. In the case of an event shown simultaneously (e.g., live) worldwide, chat rooms worldwide may be synchronized, using database 310. In an alternative embodiment, the chat rooms are grouped into localized geographical regions so that users see physically local chat messages first and have improved interactivity with these local messages.

A feature of one embodiment disclosed herein, for example, is that if a user is viewing an event in a public venue such as a sports bar, the user is still able to participate in chat, because the device 101 would continue to recognize the specific event and connect the user accordingly to the appropriate chat room.

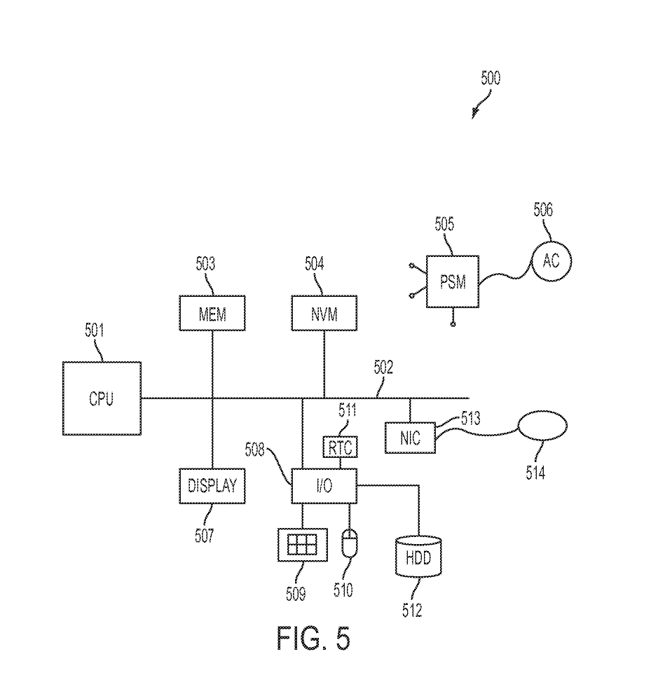

FIG. 5 provides an overview of a computer system 500 that may be implemented in any of the various locations throughout system 100. As used herein, computer system 500 may comprise any computer apparatus that provides (i.e., stores and/or transmits) information in a form accessible by a machine (e.g., a computer, network device, personal digital assistant, manufacturing tool, any device with a set of one or more processors, etc.). Practitioners will appreciate that various modifications and changes may be made to computer system 500 without departing from the scope of the disclosed systems and methods.

CPU 501 is connected to bus 502, to which bus is also connected memory 503, nonvolatile memory 504, display 507, I/O unit 508, and network interface card (NIC) 513. I/O unit 508 may be connected to keyboard 509, pointing device 510, hard disk 512, and real-time clock 511. NIC 513 connects to network 514, which may be the Internet or a local network, which local network may or may not have connections to the Internet.

Friends' Favorites

Users of the systems and methods described herein may access a variety of different types of media, such as an audio/video presentation (e.g., a live or prerecorded TV show), or a song by a certain artist. As described below, embodiments of the present disclosure can help such users quickly and efficiently identify entities associated with such media. Among other things, this allows users to meet and collaborate with others sharing the same tastes and interests as the user.

As used herein, the term “entity” may include any person, website, corporation, organization, or other thing. A user need not personally know, or be in contact with, any entity for the entity to be of interest to the user. For example, entities associated with a user and/or media may include: the user's real-life and/or social networking friends; other fans of the same or different media; artists, directors, and other individuals responsible for producing the media; the holding company that produces the media; and websites and social networks hosting reviews or content related to the media.

Embodiments of the present disclosure can also enable a user to quickly see all the user's Social Network connections that have accessed the same audio/video presentation being accessed by the user through his computing device. Throughout this disclosure, the “access” of media refers to any action associated with the media, including viewing information on the media prior to purchasing or renting the media. Access of the media may also refer to uploading, downloading, viewing, listening, opening, and/or commenting on the media. For example, a list of entities who have accessed the same media a user is accessing (e.g., by playing an audio-visual presentation on a media player) may be compiled by automatically searching content on one or more websites and/or social networks. The list of entities may be displayed in conjunction with presentation of the media, along with information (such as comments and reviews) related to the media and attributable to the entity. A user can thereby quickly access this information at the same time the user accesses the media, such as when the user is reading a description of a movie or song and deciding whether to purchase or rent it. Among other things, presentation of the information by the embodiments of the present disclosure may help a user to rapidly determine whether the user is likely to enjoy the media or not, and to find other types of media the user is likely to enjoy (whether or not related to the media the user is currently accessing) based on the information associated with the list of entities.

The list may include any type of entity and any type of information in any format. In some embodiments, the list may be configured to only include entities that are currently online (e.g., connected to a website or social network) when the media is being presented to the user. Embodiments of the present disclosure may operate in conjunction with the presentation of any desired form of media, such as real-time or pre-recorded streaming audio or video. Additionally, the information associated with an entity and displayed in conjunction with presentation of media need not be specific to the exact media being presented to the user. Instead, embodiments of the present disclosure may be configured to display information and entities related to the media the user is currently accessing, such as other episodes of a television show, other albums by a musician, other movies including an actor, and the like.

Embodiments of the present disclosure may also be used to present offers and advertising to users. Such offers and ads may be specially designed or targeted to a particular user based on information gathered from websites and social networks used in generating lists of entities and information associated with the media being accessed by a user. Likewise, content of interest to the user may be automatically identified and offered to the user based on information gathered by the systems and methods of the present disclosure.

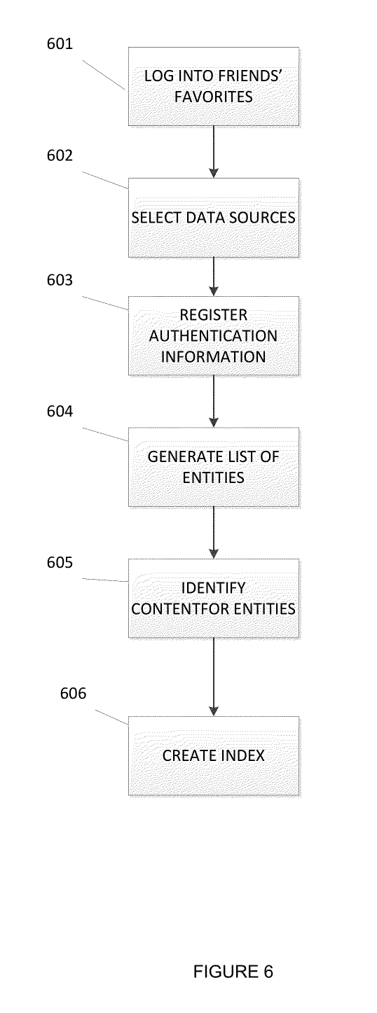

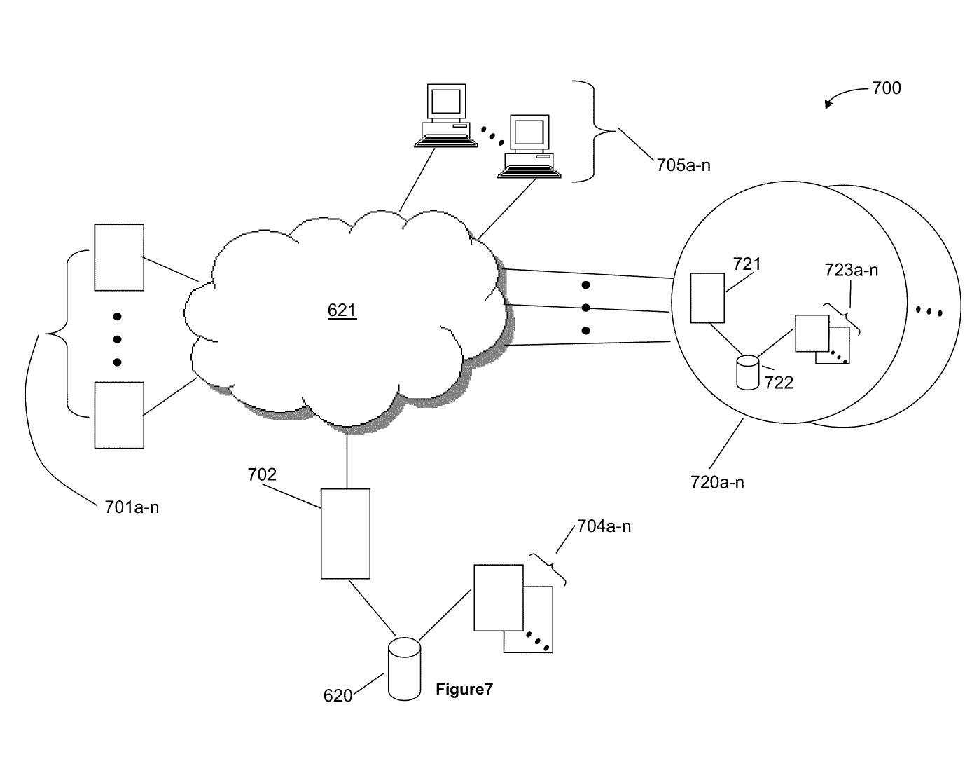

FIG. 6 shows an exemplary process 600 for identifying entities associated with various types of media. In step 601, the user logs into an application running on a computing device. Throughout this disclosure, this application may be referred to as the “Friends' Favorites” application. While FIG. 6 describes one exemplary embodiment, other embodiments of the present disclosure may incorporate any combination of the features of the Friends' Favorites application described herein, as well as features that may be performed by other software or hardware components. The Friends' Favorites application may be configured to operate on a personal computer, mobile device, laptop, or on (or in conjunction with) any other computing device or system, including system 700 depicted in FIG. 7 and described below. The Friend's Favorite application may be implemented via any combination of software operating on a user's computing device (e.g., computers 721) and software hosted by a server (e.g., server 702), such as via a web-based application hosted on server 702 and accessed by the user of computer 721 via a web browser.

In step 602, the Friends' Favorite application receives a list of websites and/or social network applications in which the user currently participates or that are of interest to the user for any reason. This list may be received in any suitable manner, such as from the user via the user interface and/or by automatically scanning the contents of the user's computing device (e.g., examining the user's internet favorites list and installed social media applications). In step 603, the user registers the user's authentication information (e.g., user name and password) for the selected social networks and websites with the Friend's Favorites application. The Friend's Favorites application may first access the identified social networks and web sites and, if it is determined authentication is required, request the necessary information from the user. Once the authentication information is received, the Friends' Favorites application may automatically, or in response to user input, access a website or social network using the authentication information. Entry and storage of the authentication information may be encrypted to protect it from inappropriate access. Likewise, the authentication information may be automatically deleted once the Friend's Favorites application generates the list of entities.

In step 604, the Friends' Favorites application creates a list of all entities associated with the user based on the content of the websites and social networks identified in step 602. Such entities may include, for example, a user's friend from one or more social networks, an entity to which the user subscribes to (e.g., to receive news updates, blogs, podcasts, social media updates, and the like), a user from a message board or chat room that the user has previously communicated with, an entity listed in a contact list for the user, and/or an entity having an association to media accessed (previously or currently) by the user.

In step 605, the Friends' Favorites application accesses the websites and social media networks listed in step 602 to identify content that is attributable to each entity listed in step 604. Such content may include, for example, positive or negative commentary on various media, links posted by the entity to commentary by others, and/or links to other media. Embodiments of the present disclosure may be configured to search and retrieve all content attributable to a particular entity. Alternatively, content may be selectively retrieved based on any suitable factor, such as the content's relevance, the media to which it applies, when the content was posted, and/or whether the content is indicative of a positive or negative view of a particular song, TV show, movie (or category thereof). The Friends' Favorites application may retrieve content from any number of different data sources in any desired manner, including by retrieving data via an application programming interface (API) used by a social network.

In addition to identifying information associated with various entities, embodiments of the present disclosure may also search websites, social networks, and content on the computing device or other devices for information associated with the user himself. Embodiments of the present disclosure may be configured to search any suitable data source for content attributable to an entity or the user, such as the websites and social networks identified in step 602, as well as other websites, email or SMS servers, and other systems. Furthermore, content (such as chat room logs, the user's Internet favorites list, emails or texts) stored on the user's own computing device to identify comments made by the user or entities associated with the user.

In one example, the Friends' Favorites application may be configured to search for content by the user or the user's friends regarding a TV Show. The application may first identify all websites with information related to the TV show, then search each of those websites and retrieve information attributable to an entity associated with both the user and the TV show in some capacity. Such information may include, for example: the user's “likes” posted on the TV show's social network page; comments about the TV show made by a person having the same email address as a person in the user's contact list on a message board; comments by the user from a chat log stored in the memory of the user's computing device; and a post regarding an actor in the TV show made by a person having the same name as a person listed as a friend of the user on a social network. Such information may be analyzed to verify it can be attributed to the user or an entity associated with the user, and then indexed and stored in a database.

In step 606 Friends' Favorites creates an index of the entities and the information attributable to each entity. The index may be generated in any format, and preferably stores data in a manner to help facilitate quick searching and retrieval of information. In one exemplary embodiment, the Friends' Favorites application maps each piece of information (e.g., favorites and “likes”) to a unique “favorites” identifier, such as an identifier for a TV show used by a social network. Commentary (including “likes”) from multiple sources can then be mapped to the unique identifier, allowing the application to pre-compute indexes for fast searching and grouping.

Among other things, the index provides the Friend's Favorites application with a full catalog of a user's friends and other entities and their respective interests, likes and dislikes, and other content so that the user can find media matching the user's own tastes and interests very quickly. The Friends' Favorite application can create indexes of all entities having positive commentary on the same media, and group or rank the media based on which media has the most favorable commentary from a set of entities. The application may also create indexes related to various forms of media and the entities associated therewith, grouped according to any desired criteria (e.g., by popularity) across any desired category. For example, the application may create indexes for quickly identifying: a most popular TV show, a most popular song, most popular celebrities, most downloaded music, a most-talked-about artist, etc.

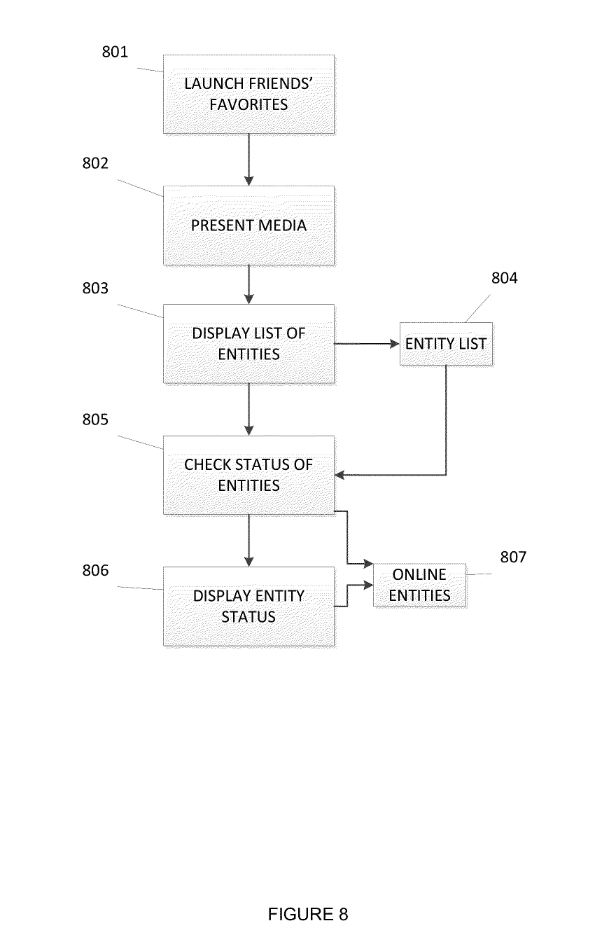

FIG. 7 shows an overview of an exemplary system 700 that may be used in conjunction with any of the other systems and methods disclosed herein, including methods 600 and 800 in FIGS. 6 and 8, respectively. In system 700, server 702 is connected to data store 620, which store may be a disk drive or any suitable type of data storage. Data store 620 contains various software components 704a-n, which may include, but are not limited to, data objects, databases, executable programs and drivers, and an operating system. Server 702 may communicate with the other components of system 700 via the Internet 621.

Also connected to Internet 621 are user sites 720a-n. Each site 720a-n (not all sites shown) contains at least one computer 721, with at least one available data store 722. Each data store 722 may include software components 723a-n, which may include any of the same components described above for 704a-n. Each computer 721 may include, or operate in conjunction with, any number of other devices and peripherals, such as a keyboard, pointing device, monitor, audio input and output devices, and any other suitable device.

System 700 also includes social networks 701a-n. Social networks 701a-n may be interfaced with in any suitable manner, such as via a website and/or via communication between a software application and a server hosting the social network. Also shown are user computing devices 705a-n, which include any suitable computing device capable of communicating with one or more of the other components in system 700 (e.g., the server 702 and social networks 701a-n) via the Internet 621. User computing devices 705a-n may include, for example, a personal computer with a display, a keyboard, pointing device, and other commonly included peripheral and integrated devices. Computing devices 705a-n may also include laptops, tablets, smart phones, or any other device. Computers 705a-n are connected to the server 702 and social networks 701a-n through the Internet 621.

FIG. 8 shows an exemplary process 800 according to various aspects of the present disclosure. In step 801 the Friends' Favorites application is launched. In step 802, media is presented to the user on the user's computing device. In this context “presenting media” may include any action associated with the media, such as selecting or opening a file; playing an audio, visual, or audio-visual presentation using a third-party media players or program; accessing the media using a component of the Friend's Favorite application or another proprietary software application; and combinations thereof. The presentation of the media in step 802 may utilize the user interface of the user's computing device, as well as any other software or hardware components of the computing device.

In step 803, the Friends' Favorites application detects the presentation of the media in step 802, identifies one or more entities associated with the presented media, retrieves information related to the entity and/or the presented media, and displays (via the user interface of the user's computing device) a list of entities (804) associated with the medium. The Friends' Favorite application may detect the presentation of the media in any desired manner. For example, the application may periodically scan the computing device to detect and identify processes related to the presentation of media as they are created (such as the opening of a media player playing an audio or video file).

Entities associated with the presented media can be identified in any suitable manner. For example, a potential list of entities may be pulled from a list of entities generated from a user's social networks and other sources, such as the list of entities generated in step 604 of FIG. 6 described above.

Information related to an entity and/or presented media may be retrieved from any desired source, such as from information stored in a database in communication with the computing device. Information may also be retrieved by accessing a website or server via a network (such as the Internet) and searching such websites and servers for content related to the presented media and attributable to an entity. Likewise, the Friends' Favorites application may retrieve information previously gathered from websites and servers (e.g. hosting social network applications) and stored in an index of information such as is generated in step 606 of FIG. 6 (described above).

The Friends' Favorites application may display the list of entities, and information associated with each entity, in any suitable manner. For example, the list of entities may be displayed concurrently with the media being presented, such as in a portion of the media player presenting the media or in a window of another application, including the Friends' Favorites application itself The list of entities and information may also be overlaid (e.g. in partially transparent font) over the presentation of the media. The list of entities and information may also be presented using any desired user interface features, such as using links to the information, expandable tree views, popup windows, and the like.

In step 805, the Friends' Favorites application may display information regarding the status of one or more entities in the list of entities 804. The set of websites and servers to review for determining the status an entity may include some or all of the websites and social networks identified in step 602 of FIG. 6, as well as other sources. The status information may be displayed automatically, in response to user input, and/or in response to detecting a change in the status of an entity. In one exemplary embodiment, the Friends' Favorites application is configured to access one or more websites and/or servers via the Internet and determine, based on the content of the websites or servers, whether a particular entity is currently connected to the website or server. The application may display an “online” indicator to show that an entity is currently connected to any one website or server, and an “offline” indicator otherwise. The application may also specifically identify to which websites and servers the entity is currently connected. Alternatively, the application may display only those entities currently connected to at least one website or server in a list of online entities 807, and omit those entities not connected. The application may also provide a link to open a chat window with any of the online entities in list 807, either via a third-party communication program, a chat or messaging program provided via a social network or other website, and/or via a chat function built into the Friends' Favorites application.

Embodiments of the present disclosure may provide numerous advantages to users, such as, for example, discovering which new shows, artists, songs, celebrities, movies, and the like are popular among a user's friends or other entities of interest to the user. Additionally, embodiments of the present disclosure may help a user to meet new friends and entities of interest to the user based on, for example, common interests in music, movies, TV shows, and other forms of art and media. Embodiments disclosed herein also allow the user to quickly identify such entities, see their common interests, and engage them (e.g., via chat) to discuss their common interests. In some other cases, the features described above can also be used as a way to discover new forms of media and to rent or purchase the media.

The features described herein can also be used to automatically identify and deliver content that is likely to be of interest to the user. For example, the Friends' Favorites application may be configured to search one or more websites, social networks, servers, and/or databases for comments or other references to media by the user of the computing device. The comments and references may then be analyzed to identify favorable or unfavorable perspectives by the user on a particular aspect of media, such as an artist, a television show, a movie, an actor, a director, a genre of media, or the like. Based on the analysis, information regarding media that is likely to be of interest to the user can then be presented to the user via, for example, an electronic communication (such as an email or SMS text message) or via the user interface of the user's computing device. The analysis may include, for example, comparing similarities between the media to which the user's comments/references relate and media the user has not been presented to the user. In this manner, previously-presented media receiving a positive reference from the user can be used to identify new media (similar in one or more aspects to the presented media) to suggest to the user.

For example, if the user posts on a message board that he/she enjoyed a television sitcom starring a particular actor (i.e., a positive reference to the show), but hated a science fiction movie starring the same actor because the user's comments indicate he/she dislikes the science fiction genre (i.e., a negative reference to the genre of science fiction), the Friends' Favorites application may be configured to identify other television shows and movies starring the actor, but exclude all media of a science fiction nature.

Additionally, media likely to be of interest to the user may be identified based on media previously presented to the user's friends or accessed by other entities of interest to the user. For example, when media is presented to the user via the user interface, the displayed list of entities may include an indication as to which entities in the list have already viewed the same movie, listened to the same song, etc. Additionally, the Friends' Favorites application can, based on the retrieved information from websites and social networks attributable to each entity, present a quick visual indicator for each entity reflecting the entity's opinion of the media. For example, if a friend on the user's social network expressed a negative comment on a movie the user is currently watching or considering renting/buying, the Friends' Favorites application may display a “thumbs down” icon next to the friend's social network id. In this manner, a user can quickly see how his or her friends and other entities with similar interests and tastes as the user view the media, and decide to pursue or avoid particular media as a result of the information.

The media may be presented to the user and other entities in any suitable manner. In one exemplary embodiment, media such as a movie may be presented to multiple users in conjunction with a service provided by a social network, such as a videoconferencing service. A participant of such a service may be connected to a group of people watching the same content, and may be able to comment on the movie in real-time via a chat window provided in conjunction with the movie.

As described previously, a user of the Friends' Favorites application may be able to determine which of the user's friends and other entities of interest to a user have previously watched particular media content, and to see their opinions of the content. Embodiments of the present disclosure may also provide a display showing the content that the user's friends and other entities of interest to the user are currently accessing. In this manner, a user can quickly see the television programs, movies, music, and other media content being accessed by the entities associated with the user and, if the user desires, access the same content.

Embodiments of the present disclosure may periodically present a poll or questionnaire to the user to, for example, ask the viewer for information regarding a particular channel, provider, television show, and the like to allow content providers to learn more about the preferences of their users. Such polls and questionnaires may be of any length and in any desired format. For example, a poll or questionnaire may be presented in a multiple-choice format, allowing a user to answer the questions (or opt out of the questionnaire) using a pointing device coupled to the user's computing device.

Polls, questionnaires, offers, and other content may be provided to the user at various points during the presentation of the media. For example, advertising may be provided to the user at a certain points in a media presentation, and may be passive or interative (i.e., requiring user response to continue). Among other things, such interactions with the user not only increase the ability of content providers to identify a user's preferences in order to recommend additional content of interest to the user, but may lead to the user engaging in follow-up activities, such as the user creating or distributing polls to entities associated with the user. The polls, questionnaires, advertising, and other additional content may be combined with incentive programs to encourage the user to participate.

The Friends' Favorites application may be configured to identify which entities currently subscribe or belong to various services offered by a social network. Using the example above of the movie viewed by a group of friends via the videoconferencing feature of a social network site, the Friends' Favorites application may (automatically or in response to input from the user) identify one or more entities that, for example, have not seen the movie, and transmit electronic communications to entities associated with the user inviting them to join the videoconference, sign up with the social networking site, or both. The invitation can be sent directly from the user's computing device (e.g., via an email or SMS text) or may be transmitted via the social networking site.

Embodiments of the present disclosure may be configured to identify the media accessed or presented using the computing device in a variety of different ways. In some cases, identifying the media may be accomplished by accessing information from the provider of the media, such as the artist, album, and title of a particular song. In other cases, such information may be determined from meta data associate with the media and stored in a file containing the media or in another file associated with the media file. Such meta data may include, for example, the name of the media file, the title of a work (e.g., movie or song) stored in the media file, the owner of the media, and other information.

In other cases, identification of the media may be determined by identifying one or more characteristics of the media and comparing the characteristic(s) to a library or database of characteristics associated with known media. In this manner, embodiments of the present disclosure can help identify media content even when there is no explicit electronic identification bundled with the media itself. In one exemplary embodiment, an audial and/or visual characteristic is collected from the media presentation and compared against a library of characteristics associated with known media. The library may be stored locally on the computing device presenting the media or on another device, such as in the database of a server in communication with the computing device via the internet.

Various computing hardware, software, and networking components for facilitating the disclosed features of system 100 have been described herein. The various hardware components include, for example, computing devices comprising one or more microprocessors and memory structures (e.g., RAM and ROM). In addition to the specifically disclosed application programming logic residing at the client device 101 and operating center 110, systems 100 and 700 may incorporate various database management systems, security modules, user management modules, firewalls, and the like. The subsequent paragraphs describe such hardware and software features in greater detail; however, practitioners will appreciate that the following is neither entirely inclusive or exclusive of the components that may be utilized in the execution of the disclosed features.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a tangible machine readable medium includes any apparatus that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

The description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

The use of headings herein is merely provided for ease of reference, and shall not be interpreted in any way to limit this disclosure or the following claims.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by one embodiment and not by others. Similarly, various requirements are described which may be requirements for one embodiment but not other embodiments. Unless excluded by explicit description and/or apparent incompatibility, any combination of various features described in this description is also included here.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A computer-implemented method comprising:
detecting, by a computing device, media presented via a user interface of the computing device;
in response to detecting the presentation of the media, identifying, by the computing device, an entity associated with the media being presented;
retrieving information that is related to both the entity and the presented media; and
displaying, via the user interface, the retrieved information.

2. The method of claim 1, wherein retrieving the information includes retrieving the information from a database in communication with the computing device.

3. The method of claim 1, wherein retrieving the information includes:
accessing one or more websites via the Internet; and
searching each of the one or more websites for references to the presented media attributed to the entity.

4. The method of claim 1, further comprising:
accessing one or more websites via the Internet;
determining, based on content on the one or more websites, whether the entity is currently connected to the one or more websites; and
indicating, via the user interface, whether the entity is connected to at least one of the one or more websites.

5. The method of claim 1, wherein identifying the entity associated with the media being presented includes selecting the entity from a list of entities.

6. The method of claim 5, wherein the list of entities is generated by:
receiving, via the user interface, a list of one or more social networks in which the user participates;
identifying, based on content of the one or more social networks, entities associated with the user; and
adding the identified entities associated with user to the list of entities.

7. The method of claim 6, further comprising:
receiving, from the user via the user interface, log-in information for accessing at least one of the one or more social networks; and
automatically accessing the at least one social network using the received log-in information.

8. The method of claim 6, further comprising:
determining, based on content on the one or more social networks, whether a respective entity is currently connected to at least one of the one or more social networks; and
including the respective entity in the list of entities responsive to determining that the respective entity is currently connected, or omitting the respective entity from the list of entities responsive to determining that the respective entity is not currently connected.

9. The method of claim 6, further comprising:
searching each of the one or more social networks for media references attributed to the user of the computing device;
identifying, based on the media references attributed to the user, media likely to be of interest to the user; and
presenting, via the user interface, information regarding the media likely to be of interest to the user.

10. The method of claim 9, wherein identifying the media likely to be of interest to the user includes one or more of:
searching each of the one or more websites for references by the user to media previously presented to the user;
analyzing similarities between media not previously presented to the user and media previously presented to the user for which the user has made a positive reference; and
identifying media not previously presented to the user for which an entity from the list of entities has made a positive reference.

11. The method of claim 5, further comprising indicating, via the user interface, which entities from the list of entities have previously accessed the media being presented.

12. The method of claim 5, wherein the media is presented in conjunction with a service provided via a social network, the method further comprising transmitting, to an entity from the list of entities, an invitation to join the service.

13. The method of claim 12, further comprising providing an offer to the entity receiving the invitation to join the service via the social network, wherein the offer is based on information about the entity receiving the invitation stored in conjunction with the list of entities.

14. The method of claim 5, further comprising identifying to the user, via the user interface, media currently presented to an entity from the list of entities.

15. The method of claim 14, further comprising:
receiving, via the user interface, a selection of the media currently presented to the entity from the list of entities; and
in response to the selection, presenting, via the user interface, the media presented to the entity from the list of entities.

16. The method of claim 1, further comprising storing the retrieved information in a memory in communication with the computing device.

17. The method of claim 16, wherein the retrieved information and information related to both the entity and other media are stored in a searchable index.

18. The method of claim 1, wherein detecting the media presented via the user interface includes identifying the presented media based on one or more of:
an audio characteristic of the presented media;
a visual characteristic of the presented media;
file information for the presented media;
meta data for the presented media; and
comparing a characteristic of the presented media to a library of characteristics associated with known media.

19. A non-transitory, computer-readable medium storing instructions that, when executed, cause a computing device to:
detect media presented via a user interface of the computing device;
in response to detecting the presentation of the media, identify an entity associated with the media being presented;
retrieve information that is related to both the entity and the presented media; and
display, via the user interface, the retrieved information.

20. A system comprising:
a user interface;
at least one processor in communication with the user interface; and
memory in communication with the at least one processor and storing instructions that, when executed by the processor:
detect media presented via the user interface;
in response to detecting the presentation of the media, identify an entity associated with the media being presented;
retrieve information that is related to both the entity and the presented media; and
display, via the user interface, the retrieved information.
